(19) United States
(12) Patent Application Publication
(10) Pub. No.: US 2025/0021084 A1
(43) Pub. Date: Jan. 16, 2025

(54) OPERATION MANAGEMENT SYSTEM

(71) Applicant: TOYOTA JIDOSHA KABUSHIKI KAISHA, Aichi-ken (JP)

(72) Inventors: Takahiro SAKURAI, Nagoya-shi (JP); Shigefumi TOKUDA, Susono-shi (JP); Masafumi KADOI, Chita-shi (JP); Yoshio TAKIZAWA, Katsushika-ku (JP); Kensuke MATSUMOTO, Nagoya-shi (JP); Ambi SHO, Nisshin-shi (JP); Takumi BAN, Setagaya-ku (JP); Tomoyuki KAGA, Mishima-shi (JP); Hideo HASEGAWA, Nagoya-shi (JP); Kenta MIYAHARA, Edogawa-ku (JP); Shinsuke YAMAUCHI, Toyota-shi (JP)

(21) Appl. No.: 18/765,334

(22) Filed: Jul. 8, 2024

(30) Foreign Application Priority Data
Jul. 13, 2023 (JP) 2023-115062

(51) Int. Cl. G05B 19/418

(52) U.S. Cl. CPC G05B 19/41865

(57) ABSTRACT

The operation management system manages an operation of a line composed of a plurality of cooperating work subjects. The operation management system performs: setting, for each work subject, an intensity that decreases at a speed corresponding to a work speed, recovers by a recovery action, and is given a lower limit value; receiving a target handling plan for the line; creating an operation plan including at least the working speed and a timing of the recovery action by using a simulation model obtained by modeling the line so that the target handling plan is achieved while maintaining the intensity of each work subject at the lower limit value or more; and allowing the intensity of each work subject to temporarily decrease to less than the lower limit value in creation of the operation plan in response to the target handling plan exceeding a predetermined reference value.

### CROSS-REFERENCE TO RELATED APPLICATION

The present application claims priority under 35 U.S.C. § 119 to Japanese Patent Application No. 2023-115062, filed Jul. 13, 2023, the contents of which application are incorporated herein by reference in their entirety.

### BACKGROUND

### Field

The present disclosure relates to a system for managing operations of a line in a manufacturing industry or a logistics industry.

### Background Art

JP2004-127170A discloses a method of creating a production plan which is totally optimized for irregular events such as orders occurring discretely, urgent orders, and production delays in a manufacturing industry. In this method, a margin time added to the production plan is dynamically changed in conjunction with the variation of production plan creation system, thereby realizing the correspondence to the variation of the production plan, the allocation of a new production plan, and the correction of the production plan for production delay.

The above-described prior art adjusts the margin time added to the production plan to cope with the variation in the production plan. However, in such a method, when an increase in production is requested, the production can be increased only within the range of the margin time. In the manufacturing industry or the logistics industry, there can be large variation in the handling plan of the line. How to cope with the change in the handling plan, particularly, the increase in the handling plan is one of the subjects to be studied in the operation of the line.

As documents showing the technical level of the technical field related to the present disclosure, JP2007-201309A, JPH10-034499A, and JP2005-157819A can be exemplified in addition to JP2004-127170A. None of the documents listed here discloses a solution to the above problem.

### SUMMARY

The present disclosure has been made in view of the above problem. An object of the present disclosure is to provide a system that can cope with a change in a handling plan in a line of a manufacturing industry or a logistics industry, particularly, an increase in the handling plan.

One aspect of the present disclosure includes a system for managing an operation of a line composed of a plurality of cooperating work subjects. The system includes a processor, a memory coupled to or integrated in the processor, and a plurality of instructions stored in the memory. The instructions cause the processor to perform the following processing. The first processing is processing of setting, for each work subject, an intensity that decreases at a speed corresponding to a work speed, recovers by a recovery action, and is given a lower limit value. The second processing is processing of receiving a target handling plan for the line. The third processing is processing of creating an operation plan including at least the working speed and a timing of the recovery action by using a simulation model obtained by modeling the line so that the target handling plan is achieved while maintaining the intensity of each work subject at the lower limit value or more. The fourth processing is processing of allowing the intensity of each work subject to temporarily decrease to less than the lower limit value in creation of the operation plan in response to the target handling plan exceeding a predetermined reference value.

According to the above aspect, since the work speed is included in the set values of the operation plan, a variation in the target handling plan can be addressed by changing the work speed. However, if the working speed is increased, the intensity decreases more quickly, but since the set values of the operation plan include the timing of the recovery action, the intensity can be prevented from falling below the lower limit value by taking the recovery action at an appropriate timing. When the target handling plan increases beyond the reference value, the intensity is allowed to temporarily fall below the lower limit value, thereby making it possible to address a temporary rapid increase in the target handling plan.

In a first mode of the above aspect, the plurality of instructions may cause the processor to create the operation plan using the simulation model so that the intensity of each work subject is recovered to the lower limit value or more by a time when a predetermined period elapses after the intensity is decreased to be less than the lower limit value. When the intensity decreases to less than the lower limit value, it is not left as it is, but it is recovered to the lower limit value or more before the predetermined period elapses, and thus the work subject is suppressed from being continuously subjected to strong fatigue. According to the first mode, the intensity is recovered to the lower limit value or more before the predetermined period elapses, and thus it is possible to prepare for the next increase in the target handling plan.

In a second mode of the above aspect, the simulation model may include a digital twin that reproduces the line in a virtual space. In this case, the setting the intensity of each work subject may include setting the intensity individually for each work subject based on data obtained from each work subject in a real space. According to the second mode, it is possible to reflect real data obtained from work subjects in the real space in the creation of the operation plan by using the digital twin.

In the second mode of the above aspect, the creating the operation plan may include creating the operation plan individually for each work subject as long as the target handling plan is achieved. Consequently, an operation plan that matches the attributes and individuality of each work subject in the real space can be created, and the operation for each work subject will be optimized while achieving the target handling plan as a whole.

In the second mode of the above aspect, the setting the intensity individually for each work subject may include setting at least one of a maximum value of the intensity, a rate of decrease of the intensity with respect to the work speed, and the lower limit value individually for each work subject. By individually setting the value related to the intensity for each work subject, the state of each work subject in the real space can be reproduced in the virtual world of the digital twin and reflected in the creation of the operation plan.

In the second mode of the above aspect, in a case where the plurality of work subjects includes a worker, the setting the intensity of the worker may include increasing a maximum value of the intensity of the worker in accordance with work experience of the worker in the real space. By reproducing the growth of the worker in the real space in the virtual world of the digital twin, it is possible to create an operation plan in which the state of the worker in the real space is accurately reflected.

In a third mode of the above aspect, the recovery action may include a plurality of types of recovery actions having different recovery amounts and required times. In this case, the creating the operation plan may include selecting a recovery action to be taken from among a plurality of types of recovery actions. By allowing the plurality of types of recovery actions to be selected, similar to those in the real space, it is possible to create an operation plan that can improve the operation rate of the line through a lean recovery action.

In a fourth mode of the above aspect, the plurality of work subjects may include a work group that performs one work in a group. In this case, the creating the operation plan may include creating an operation plan in which the target handling plan is achieved as the entire work group while the intensity of each work subject constituting the work group is maintained at the lower limit value or more. According to the fourth mode, when one work is performed in a group, it is possible to create an operation plan that can achieve both the intensity required for each work subject constituting the work group and the achievement of the target handling plan.

In a fifth mode of the above aspect, when the plurality of work subjects includes a plurality of workers, the creating the operation plan may include changing cooperation between the plurality of workers in accordance with the level of the work speed. The degree of decrease in the intensity of each worker may be affected by the compatibility between the workers who cooperate with each other during the work. By creating an operation plan in which the cooperation between workers is changed according to the level of the working speed, it is possible to prevent a situation in which the intensity of a specific worker is extremely decreased while achieving the target handling plan.

In a sixth mode of the above aspect, in a case where the plurality of work subjects includes a plurality of work machines and a plurality of workers, the creating the operation plan may include changing a combination between work machines and workers in accordance with the level of the work speed. The degree of decrease in the intensity of each worker may be affected by the compatibility with the work machine with which the worker is combined during the work. By creating an operation plan in which the combination between work machines and workers is changed according to the level of the work speed, it is possible to prevent a situation in which the intensity of a specific worker is extremely decreased while achieving the target handling plan.

As described above, according to the present disclosure, it is possible to manage the operation of the line so as to cope with a change in the handling plan, particularly, an increase in the handling plan.

### BRIEF DESCRIPTION OF THE DRAWINGS

FIG. 1 is a diagram for explaining an overview of an operation management system.

FIG. 2 is a diagram illustrating the configuration of the operation management system.

FIG. 3 is a diagram illustrating a first example of the operation plan.

FIG. 4 is a diagram illustrating a second example of the operation plan.

### DETAILED DESCRIPTION

### 1. Overview of Operation Management System

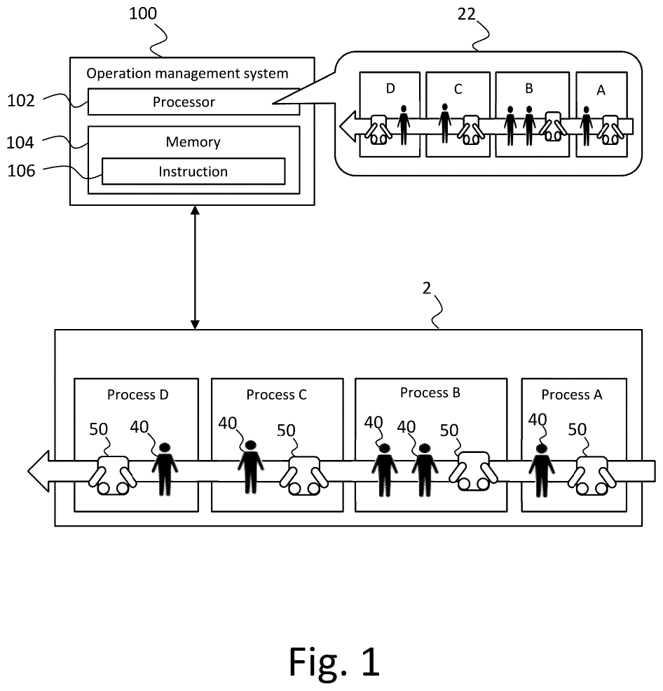

FIG. 1 is a diagram illustrating an operation management system 100 according to the present embodiment. The operation management system 100 is applied to a line 2 of a manufacturing industry or a logistics industry. The operation management system 100 manages the operation of the line 2.

The line 2 includes a plurality of processes, and is configured by a plurality of workers 40 and a plurality of work machines 50 that work in cooperation with each other. The work machines 50 include robots and equipment. In the example illustrated in FIG. 1, the line 2 includes process A, process B, process C, and process D. One worker 40 and one work machine 50 are arranged in process A, two workers 40 and one work machine 50 are arranged in process B, one worker 40 and one work machine 50 are arranged in process C, and one worker 40 and one work machine 50 are arranged in process D. The worker 40 and the work machine 50 arranged in the same process constitute a work group that performs work in cooperation with each other. In the present specification, the worker 40 and the work machine 50 that are in charge of work in the line 2 are collectively referred to as a work subject.

The operation management system 100 includes at least one processor (hereinafter, simply referred to as a processor) 102 and at least one memory (hereinafter, simply referred to as a memory) 104 coupled to the processor 102 or integrated in the processor 102. The memory 104 stores a program executable by the processor 102. The program includes a plurality of instructions 106. The program can be stored in a computer-readable non-transitory storage medium.

The plurality of instructions 106 includes instructions that cause processor 102 to generate an operating plan for the line 2. The plurality of instructions 106 also includes instructions that cause the processor 102 to function as a simulator. When the processor 102 functions as a simulator, the processor 102 reproduces the line 2 in the real space in the digital space by digital twin. Hereinafter, in order to distinguish the line 2 in the real space from the line 22 reproduced by the digital twin in the digital space, the former is referred to as a real line 2 and the latter is referred to as a digital twin line 22. The simulation using the digital twin line 22 uses real data acquired from the real line 2. The operation plan of the real line 2 is created based on the simulation result obtained from the digital twin line 22.

### 2. Configuration of Operation Management System

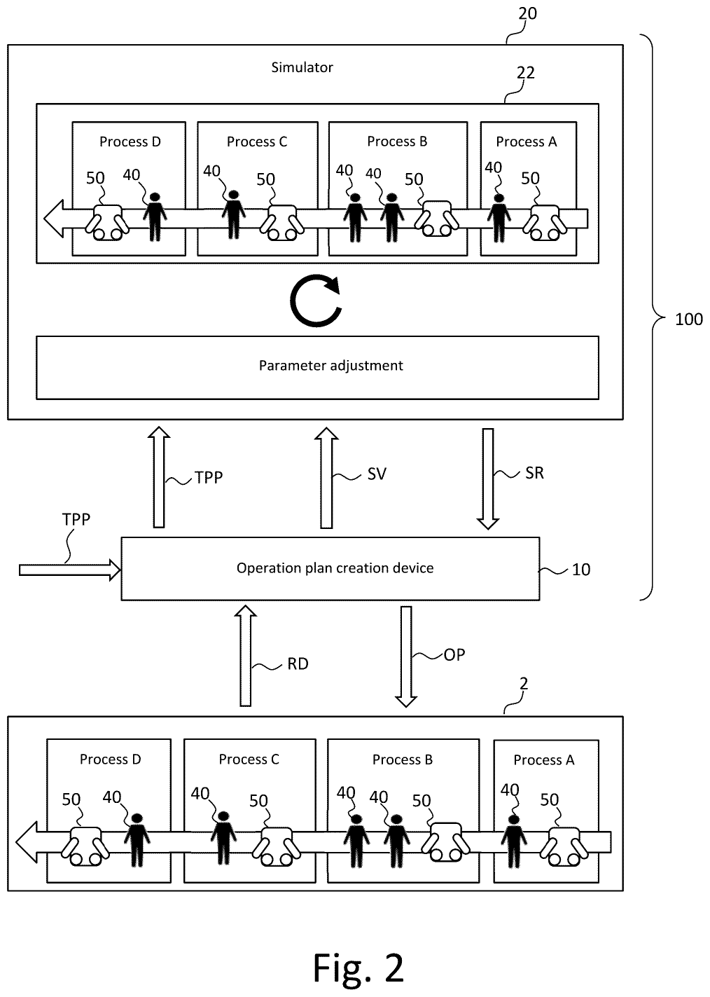

FIG. 2 is a diagram illustrating a configuration of the operation management system 100. The operation management system 100 includes an operation plan creation device 10 and a simulator 20. The operation plan creation device 10 and the simulator 20 are realized by the processor 102 executing the corresponding instructions 106. However, the operation plan creation device 10 and the simulator 20 may be realized by a single processor 102 or may be realized by separate processors 102.

The operation plan creation device 10 is a device that creates an operation plan to be presented to the real line 2. As information for creating the operation plan, a target handling plan TPP is input to the operation plan creation device 10. The target handling plan TPP is a plan for the handling amount in the real line 2 in a set handling period. The handling period is set, for example, in units of one day. The target handling plan TPP can be input to the operation plan creation device 10 from an input device (not illustrated) connected to the operation management system 100. The operator can set an arbitrary value as the target value.

A reference value is set for the target handling plan TPP. The reference value is used to determine busyness based on the handling amount required in the target handling plan TPP. A handling period in which the target handling plan TPP is equal to or less than the reference value is regarded as a normal period. A handling period in which the target handling plan TPP exceeds the reference value is regarded as a busy period. The busy period is a period in which work subjects are required to work harder than usual.

Further, real data RD acquired from the real line 2 is input to the operation plan creation device 10 as information for creating the operation plan. The real data RD includes observation data acquired by a sensor such as a camera installed in a factory or a distribution center or a wearable device worn by each worker 40. The real data RD includes a work performance value of the real line 2 in a unit period such as one day, one week, or one month. The operation plan creation device 10 is connected to a computer for data collection installed in the real line 2 via a network. The real data RD may be transmitted to the operation plan creation device 10 in real time according to the content of the data, or may be transmitted to the operation plan creation device 10 at regular time intervals.

The operation plan creation device 10 simulates the operation plan by using the simulator 20. The operation plan creation device 10 inputs the target handling plan TPP input by the operator and the real data RD acquired from the real line 2 to the simulator 20 together with the set value SV for determining simulation conditions.

The simulator 20 uses the digital twin line 22 for simulating the operation plan. The digital twin line 22 is a simulation model in which the real line 2 is reproduced in a virtual space. Thus, in the example illustrated in FIG. 2, the digital twin line 22 includes process A, process B, process C, and process D. In each process of the digital twin line 22, the same number of workers 40 and work machines 50 as the number of workers 40 and work machines 50 arranged in each process of the real line 2 are arranged.

The intensity is defined as an evaluation value for the work subject constituting the digital twin line 22. When the work subject is the worker 40, the intensity means physical intensity or mental intensity. When the work subject is the work machine 50, the intensity means mechanical intensity.

Physical intensity can be read as stamina. When there is no fatigue, the stamina of the worker 40 is the maximum, and as the fatigue accumulates, the stamina of the worker 40 decreases. The work amount that can be processed by the worker 40 is maximized when the stamina is maximized, and the work amount that can be processed is reduced as the stamina is decreased. Therefore, the stamina can be represented by the work amount that can be processed by the worker 40, that is, the workable amount. The workable amount is recovered by the worker 40 taking a recovery action such as a break or a rest, as in the case of the stamina. In the present embodiment, a numerical value obtained by normalizing the workable amount of the worker 40 with reference to the maximum workable amount of an average worker is used as the physical intensity of the worker 40.

The mental intensity can be read as stress tolerance. The stress tolerance of the worker 40 is the maximum at the start of the work, and the stress tolerance of the worker 40 decreases as the work time increases. In other words, as the stress tolerance decreases, the time available to continue working also decreases. Therefore, the stress tolerance can be expressed by a time period during which a worker can continue working, that is, a work continuable time period. The work continuable time is recovered by the worker 40 taking a recovery action such as a break or a rest, similarly to the stress tolerance. In the present embodiment, a numerical value obtained by normalizing the work continuable time of the worker 40 with reference to the maximum work continuable time of an average worker is used as the mental intensity of the worker 40.

The mechanical intensity can be read as a operable time. Unlike the worker 40, the work machine 50 does not lose stamina or concentration. However, the work machine 50 requires periodic maintenance. The maintenance may include replacement of the battery. The operable time is recovered by performing maintenance as a recovery action on the work machine 50. In the present embodiment, a numerical value obtained by normalizing the operable time until the next maintenance of the work machine 50 by the maximum operable time is used as the mechanical intensity of the work machine 50.

The setting value SV input from the operation plan creation device 10 to the simulator 20 includes a setting value related to the intensity of the work subject. Specifically, the maximum value of the intensity for each work subject, the decrease rate of the intensity with respect to the work speed for each work subject, and the lower limit value of the intensity for each work subject are set for the digital twin line 22. By individually setting the setting value related to the intensity for each work subject, the state of each work subject in the real space can be reproduced in the digital twin line 22 and reflected in the creation of the operation plan. These set values are registered in the operation plan creation device 10 in advance.

When the intensity means the physical intensity of the worker 40, the maximum value of the intensity corresponds to the maximum workable amount of the worker 40. In this case, the rate of decrease in the intensity with respect to the working speed corresponds to the rate of decrease in the workable amount with respect to the working speed. The workable amount decreases each time the worker 40 performs work, and the faster the work speed, the larger the amount of decrease in the workable amount. The lower limit of the intensity corresponds to the minimum workable amount to be left. The difference between the maximum workable amount and the workable amount that can be recovered by the recovery action is the minimum workable amount to be left.

When the intensity means the mental intensity of the worker 40, the maximum value of the intensity corresponds to the maximum work continuable time of the worker 40. In this case, the rate of decrease in the intensity with respect to the working speed corresponds to the rate of decrease in the work continuable time with respect to the working speed. The work continuable time decreases each time the worker 40 performs work, and the amount of decrease in the work continuable time increases as the work speed increases. The lower limit of the intensity corresponds to the minimum work continuable time to be left. The difference between the maximum work continuable time and the work continuable time that can be recovered by the recovery action is the minimum work continuable time to be left.

When the intensity means the mechanical intensity of the work machine 50, the maximum value of the intensity corresponds to the maximum operable time of the work machine 50. In this case, the rate of decrease in the intensity with respect to the working speed corresponds to the rate of decrease in the operable time with respect to the working speed. The operable time decreases each time the work machine 50 performs work, and the faster the work speed, the greater the amount of decrease in the operable time. The lower limit of the intensity corresponds to the operable time to be left. The difference between the maximum operable time and the operable time that can be recovered by the recovery action is the minimum operable time to be left.

The simulator 20 searches for an operation plan that can achieve the target handling plan TPP under the constraint conditions given to the digital twin line 22. The given constraint conditions include a lower limit value of the intensity set for each work subject. That is, the simulator 20 searches for an operation plan capable of achieving the target handling plan TPP while maintaining the intensity of each work subject to be equal to or greater than the lower limit value by simulation using the digital twin line 22. However, in a busy period in which the target handling plan TPP exceeds the reference value, the work subject is requested to work hard, and thus the intensity is allowed to be temporarily reduced to less than the lower limit value in the creation of the operation plan. Even in this case, the operation plan is created such that the intensity is recovered to the lower limit value or more by the time when the predetermined period elapses after the intensity is decreased to less than the lower limit value.

In the search for the operation plan in the simulation, the working speed and the timing of the recovery action are used as parameters of the digital twin line 22. Specifically, the work speed and the timing of the recovery action are parameters that affect the intensity of the work subject. As the working speed is increased, the handling amount is increased, but the rate of decrease in the intensity is increased, and the time before the intensity reaches the lower limit is shortened. However, by appropriately setting the timing of the recovery action, it is possible to prevent the intensity of work subjects from decreasing to less than the lower limit value. Even when the intensity is allowed to temporarily decrease to less than the lower limit value, it is possible to suppress the application of fatigue stronger than expected to work subjects by taking a recovery action at an appropriate timing. Note that a plurality of types of recovery actions can be selected in the simulation as in the case of the real space. By selecting a lean recovery action, an operation plan can be created that can improve the operating rate of the real line 2.

The operation plan creation device 10 creates an operation plan OP of the real line 2 based on the simulation result SR supplied from the simulator 20. The created operation plan OP is transmitted to, for example, a management computer of the real line 2. The management computer manages the operation of the real line 2 according to the operation plan OP. The operation plan OP includes at least the working speed of the real line 2 and the timing of the recovery action. By managing the operation on the real line 2 according to the operation plan OP, it is possible to achieve the target handling plan TPP imposed on the real line 2 while maintaining the intensity of each work subject to be equal to or greater than the lower limit value.

Hereinafter, the creation of the operation plan by the operation plan creation device 10 will be specifically described.

### 3. Creation of Operation Plan

The operation plan can be created for the entire real line 2. In this case, the operation plan is created so that the target handling plan is achieved in the entire real line 2 while maintaining the intensity of each work subject constituting the real line 2 to be equal to or greater than the lower limit value.

The operation plan can be created for each work group in charge of the same process. In this case, the operation plan is created so that the target handling plan is achieved for the entire work group while maintaining the intensity of each work subject constituting the work group to be equal to or greater than the lower limit value. According to this method, when one work is performed in a group, it is possible to create an operation plan that can achieve both the intensity required for each work subject constituting the work group and the achievement of the target handling plan.

Further, the operation plan may be created for each work subject. In this case, the operation plan is created so that the target handling plan of the target work subject is achieved while maintaining the intensity of the target work subject to be equal to or greater than the lower limit value. According to this method, it is possible to create an operation plan that matches the attributes and individuality of each work subject in the real space, and it is possible to optimize the operation for each work subject while achieving the target handling plan as a whole. In addition, in a case where the work subject is the worker 40, the maximum value of the intensity may be increased as the worker 40 accumulates work experience in the real space in consideration of growth due to the work experience. However, an upper limit value corresponding to the limit of growth is set for the intensity.

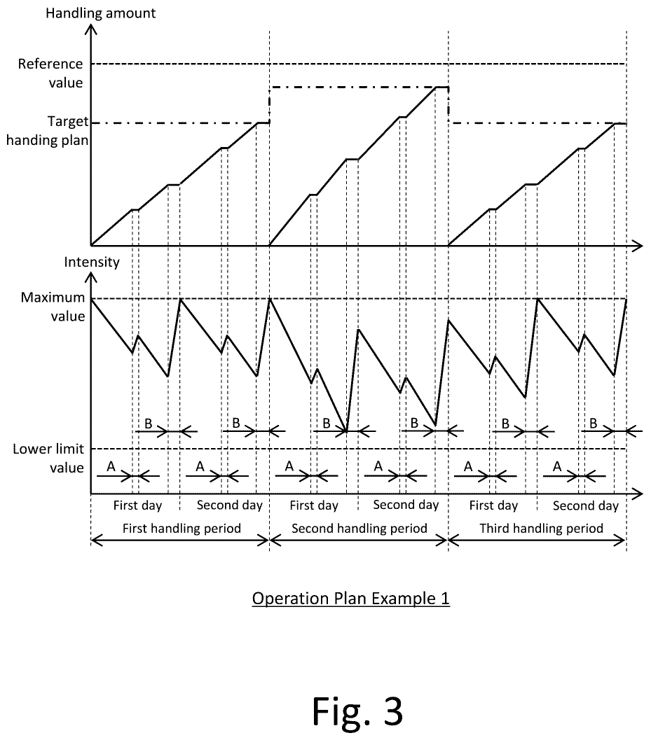

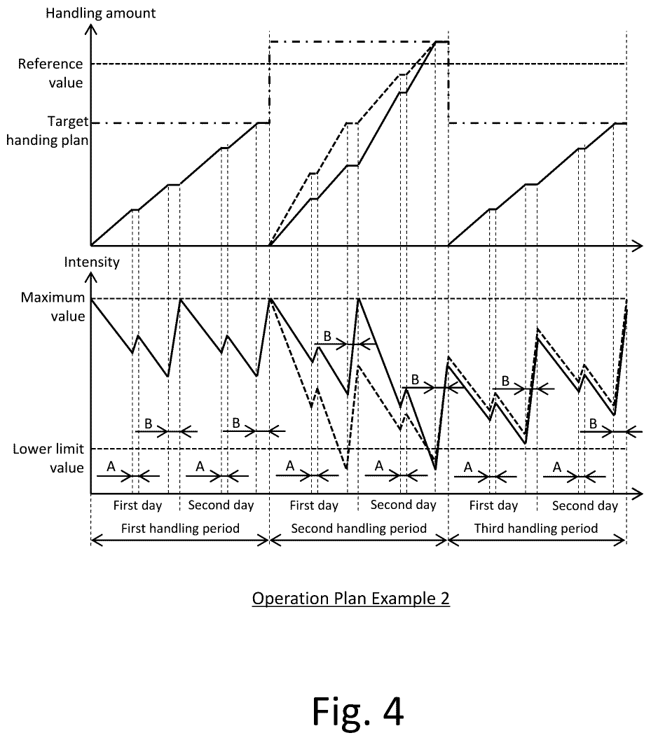

FIGS. 3 and 4 show examples of the operation plan in the case where the operation subject is a worker. In the operation plan example 1 illustrated in FIG. 3 and the operation plan example 2 illustrated in FIG. 4, the operation plans are created under the following preconditions.
Precondition 1: The target handling plan may be achieved within the handling period.
Precondition 2: One handling period is two days.
Precondition 3: One recovery action A and two recovery actions B are executed within the handling period.
Precondition 4: The recovery action A is an action requiring a short time (for example, corresponding to a lunch break), and the amount of recovery of the intensity per action by the recovery action A is small.
Precondition 5: The recovery action B is an action requiring a long time (for example, corresponding to a rest after returning home), and the amount of recovery of the intensity per one recovery action B is large.

In the operation plan example 1 illustrated in FIG. 3, the target handling plan increases in the second handling period as compared with the first handling period, and decreases again to the same level as the first handling period in the third handling period. However, even when the target handling plan increases in the second handling period, the target handling plan is within the reference value. Therefore, in the operation plan example 1, the work speed and the timing of the recovery action are determined so that the target handling plan is achieved while maintaining the intensity of each work subject at the lower limit value or more in all the handling periods from the first handling period to the third handling period.

In the operation plan example 2 illustrated in FIG. 4, as in the operation plan example 1, the target handling plan increases in the second handling period as compared with the first handling period, and decreases again to the same level as in the first handling period in the third handling period. However, in the operation plan example 1, the target handling plan in the second handling period is within the reference value, whereas in the operation plan example 2, the target handling plan in the second handling period exceeds the reference value. Therefore, in order to achieve the target handling plan in the second handling period, the intensity is temporarily allowed to fall below the lower limit value.

FIG. 4 shows two patterns of working speeds that can achieve the target handling plan in the second handling period. The first pattern is a pattern in which the working speed in the second half is made higher than that in the first half. The variation in the intensity and handling amount with the first pattern is shown by the solid lines. In the first pattern, the intensity is lower than the lower limit value only in the latter half of the second handling period. On the other hand, the second pattern is a pattern in which the working speed in the first half is made higher than that in the second half. The variation in the intensity and the handling amount according to the second pattern is shown by the dashed line. In the second pattern, the intensity is lower than the lower limit value in the first half of the second handling period, and the intensity is lower than the lower limit value in the second half of the second handling period.

In any of the patterns, when the intensity is decreased to be less than the lower limit value, it is not left, but is recovered to the maximum value by the next day by an appropriate recovery action. This can prevent work subjects from being continuously subjected to strong fatigue and can prepare for the next increase in the target handling plan. Note that either the first pattern or the second pattern may be adopted, but the first pattern can suppress continuous application of strong fatigue to work subjects.

### 4. Other Embodiments

When the work subjects constituting the real line 2 are only the workers 40, the operation plan may be created so as to change the cooperation between the workers 40 according to the level of the work speed. The degree of decrease in the intensity of the worker 40 is affected not only by the working speed but also by the compatibility between the workers 40 who cooperate with each other during the work. By creating an operation plan in which the cooperation between the workers 40 is changed according to the level of the working speed, it is possible to prevent a situation in which the intensity of a specific worker 40 is extremely decreased while achieving the target handling plan.

Further, when both the work machines 50 and the workers 40 are included in the work subjects constituting the line, the operation plan may be created so as to change the combination of the work machines 50 and the workers 40 according to the level of the work speed. The degree of decrease in the intensity of the worker 40 is affected not only by the working speed but also by the compatibility with the work machine 50 combined during the work. By creating an operation plan in which the combination of the work machines 50 and the workers 40 is changed according to the level of the work speed, it is possible to prevent a situation in which the intensity of a specific worker 40 is extremely decreased while achieving the target handling plan.

What is claimed is:

1. A system for managing operation of a line composed of a plurality of cooperating work subjects, the system comprising:
at least one processor;
at least one memory coupled to or integrated in the at least one processor; and
a plurality of instructions stored in the at least one memory and executable by the at least one processor,
wherein the plurality of instructions is configured to cause the at least one processor to execute:
setting, for each work subject, an intensity that decreases at a speed corresponding to a work speed, recovers by a recovery action, and is given a lower limit value,
receiving a target handling plan for the line,
creating an operation plan including at least the working speed and a timing of the recovery action by using a simulation model obtained by modeling the line so that the target handling plan is achieved while maintaining the intensity at the lower limit value or more, and
allowing the intensity to temporarily decrease to less than the lower limit value in creation of the operation plan in response to the target handling plan exceeding a predetermined reference value.

2. The system according to claim 1, wherein
the plurality of instructions is configured to cause the at least one processor to further execute creating the operation plan using the simulation model so that the intensity is recovered to the lower limit value or more by a time when a predetermined period elapses after the intensity is decreased to be less than the lower limit value.

3. The system according to claim 1, wherein
the simulation model includes a digital twin that reproduces the line in a virtual space, and
the setting the intensity includes setting the intensity individually for each work subject based on data obtained from each work subject in a real space.

4. The system according to claim 3, wherein
the creating the operation plan includes creating the operation plan individually for each work subject as long as the target handling plan is achieved.

5. The system according to claim 3, wherein
the setting the intensity individually for each work subject includes setting at least one of a maximum value of the intensity, a rate of decrease of the intensity with respect to the work speed, and the lower limit value individually for each work subject.
